(19) United States
(12) Patent Application Publication
(10) Pub. No.: US 2008/0067465 A1
(43) Pub. Date: Mar. 20, 2008

(54) LIQUID COINFUSION UNIT

(75) Inventors: Ichiro Kitani, Fukuroi-shi (JP); Yosuke Sakai, Fukuroi-shi (JP)

Correspondence Address: Kendall (CDFS), 445 BROAD HOLLOW ROAD, SUITE 225, MELVILLE, NY, 11704, US

(73) Assignee: TYCO HEALTHCARE GROUP LP, Mansfield, MA (US)

(21) Appl. No.: 11/847,609

(22) Filed: Aug. 30, 2007

(30) Foreign Application Priority Data
Sep. 1, 2006 (JP) 2006-238070

(51) Int. Cl. F16K 27/00

(52) U.S. Cl. 251/336

(57) ABSTRACT

The present invention provides a liquid coinfusion unit that can prevent backflow. The coinfusion unit incorporates a closure mechanism (21a, 21b) for closing a fluid connection to an inlet port (14) while maintaining a fluid connection between a mixing port and an outlet port (13), thereby preventing the backflow of a medicinal liquid through the inlet port. Operation of a manipulating element (22a, 22b) by a user causes the closure mechanism to obstruct a fluid flow channel from the inlet port (14) and on release of the manipulating element, the closure mechanism returns to a fluid flow configuration.

### FIELD OF THE INVENTION

The present invention pertains to a liquid coinfusion unit that has a main flow channel for feeding medicinal liquid or another liquid from an upstream tube via a chamber to the downstream tube, and a secondary flow channel for feeding medicinal liquid or another liquid from a mixing tube to the main flow channel.

### BACKGROUND OF THE INVENTION

In the prior art, physiological saline, medicinal liquid or the like is fed into the body of the patient by means of a transfusion tube. In such cases, a flow rate adjusting device is used to adjust the flow rate of the medicinal liquid or the like flowing through the transfusion tube (for example, see Japanese Kokai Patent Application No. Sho 62[1987]-172962). Said flow rate adjusting device is composed of an inner wall with its lower portion formed in a valve chamber, a main body composed of two tube joints having through-holes and extending from the two sides of the vacuum chamber to the outside, respectively, and a movable part rotatably mounted in the inner wall of the main body. The two tube joints of the main body are formed vertically offset from each other with respect to the central axis, and the lower portion of the movable part is formed as a slope. Consequently, by rotating the movable part, it is possible to open/close the through-hole by changing the size of the opening formed by the through-holes on the two tube joints in the movable part. As a result, it is possible to adjust as desired the flow rate of the medicinal liquid or the like fed from one tube joint via the vacuum chamber to the other tube joint.

However, the aforementioned flow rate adjusting device is associated with certain problems. It is used with transfusion tubes for feeding one type of physiological saline, medicinal liquid or the like into the body of the patient, and it is not used for feeding a plurality of types of physiological saline, medicinal liquid, etc. into the body of the patient. As a result, a liquid coinfusion unit has been developed that can control the supply of a plurality of types of physiological saline, medicinal liquid, etc. to the patient by connecting between or blocking plural transfusion tubes. When said liquid coinfusion unit for feeding a plurality of medicinal liquids, etc. is used to feed one medicinal liquid, etc., if another medicinal liquid, etc., is fed together with the first one, then the other medicinal liquid, etc., will flow back and invade the upstream side of the tube for feeding said first medicinal liquid, etc. In order to prevent said back flow, a liquid coinfusion unit that can switch the flow channel by rotating a valve body has also been developed. However, the process for connecting between or blocking the plurality of tubes is complicated, which is undesirable.

The purpose of the present invention is to solve the aforementioned problems of the prior art by providing a liquid coinfusion unit characterized by the fact that it is possible to prevent the back flow of the medicinal liquid, etc. and to facilitate the operation for connecting or blocking any of the tubes of the plurality of tubes.

### SUMMARY OF THE INVENTION

In one aspect of the present invention is provided a liquid coinfusion unit. The coinfusion unit generally comprises a liquid coinfusion unit main body which has an upstream tube and a downstream tube extending outwardly from two respective sides of an interior chamber. The unit further comprises a mixing tube which is formed on an upper part of said chamber and which communicates with a first flow channel that extends from said upstream tube to said downstream tube via said chamber such that a second flow channel extends from said mixing tube to said downstream tube. Attached to the main body is a closure mechanism arranged to be able to releasably block said first flow channel. A manipulating element outside of the chamber connected to said closure mechanism can be manipulated to displace said closure mechanism.

### BRIEF DESCRIPTION OF THE FIGURES

Various embodiments of the present invention will now be described, by way of example, with reference to the accompanying drawings in which:

FIG. 1 is a plan view illustrating the liquid coinfusion unit in Embodiment 1 of the present invention;

FIG. 2 is a side view of the liquid coinfusion unit in a first embodiment;

FIG. 3 is a front view of the liquid coinfusion unit in the first embodiment;

FIG. 4 is a cross-sectional view along 4-4 in FIG. 2;

FIG. 5 is a cross-sectional view along 5-5 in FIG. 1;

FIG. 6 is a cross-sectional view illustrating the state in which the flow channel of the liquid coinfusion unit shown in FIG. 4 is blocked;

FIG. 7 is a cross-sectional view illustrating the state in which the flow channel of the liquid coinfusion unit shown in FIG. 5 is blocked;

FIG. 8 is a cross-sectional view illustrating the state in which the flow channel of the liquid coinfusion unit in a second embodiment is connected;

FIG. 9 is a cross-sectional view illustrating the state in which the flow channel of the liquid coinfusion unit in the second embodiment is blocked;

FIG. 10 is a cross-sectional view illustrating the state in which the flow channel of the liquid coinfusion unit in a third embodiment is connected;

FIG. 11 is a cross-sectional view illustrating the state in which the flow channel of the liquid coinfusion unit in the third embodiment is blocked;

FIG. 12 is a cross-sectional view illustrating the state in which the flow channel of the liquid coinfusion unit pertaining to a fourth embodiment is connected;

FIG. 13 is a cross-sectional view illustrating the state in which the flow channel of the liquid coinfusion unit in the fourth embodiment is blocked:

FIG. 14 is a cross-sectional view illustrating the state in which the flow channel of the liquid coinfusion unit in a fifth embodiment is connected;

FIG. 15 is a cross-sectional view illustrating the state in which of the flow channel of the liquid coinfusion unit in the fifth embodiment is blocked;

FIG. 16 is a cross-sectional view illustrating the state in which the flow channel of the liquid coinfusion unit in a sixth embodiment is connected; and

FIG. 17 is a cross-sectional view illustrating the state in which of the flow channel of the liquid coinfusion unit in the sixth embodiment is blocked.

### DETAILED DESCRIPTION OF THE INVENTION

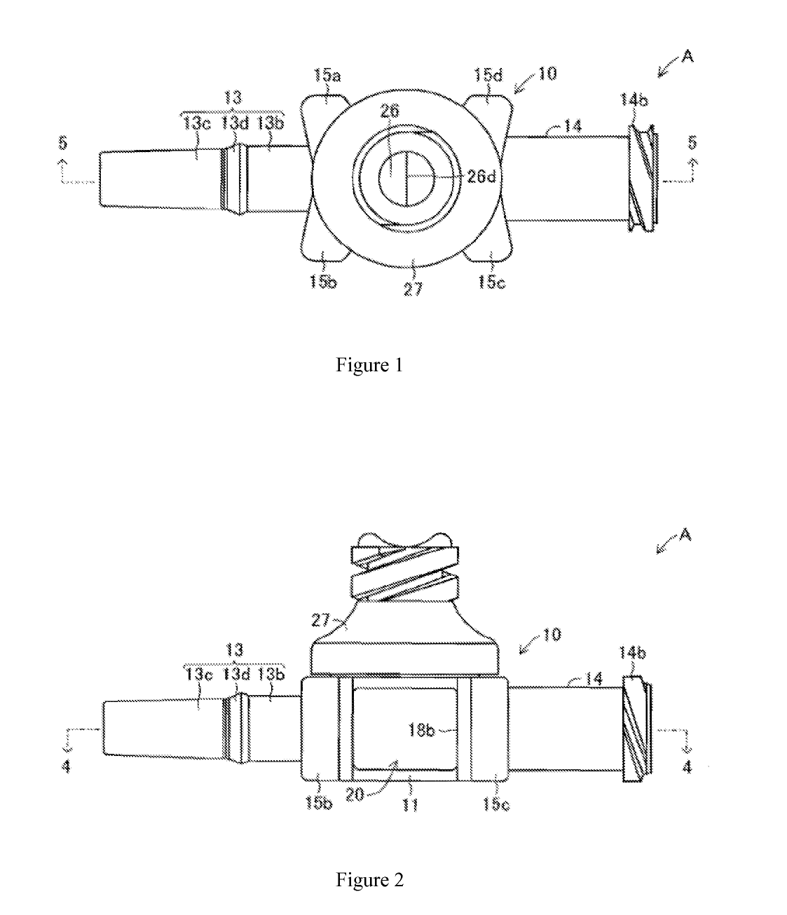

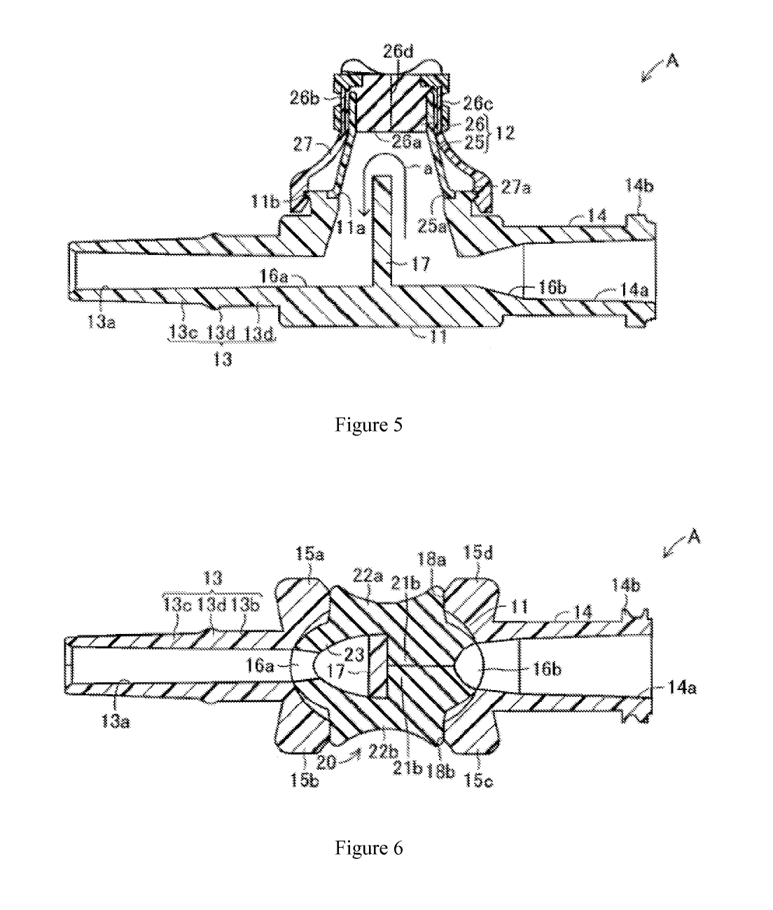

The present invention is directed to a liquid coinfusion unit. In one embodiment of the present invention, FIGS. 1-3 illustrate liquid coinfusion unit A of this first embodiment. Liquid coinfusion unit (A) is composed of liquid coinfusion unit main body (10) and open/close manipulating part (20). Said liquid coinfusion unit main body (10) is composed of chamber (11), which is approximately cylindrical in shape and short in length in the axial direction. It is set with its axial direction oriented vertically, mixing tube (12) set above chamber (11) (see FIG. 5), and a pair of downstream (13) and upstream (14) tubes formed on the outer peripheral surface of chamber (11) and extending coaxially while maintaining an angle of 180°.

The main body of chamber (11) is formed with a cylindrical shape with the lower end closed and the upper end open and is elliptical in plan view. On its outer peripheral surface, holding protrusions (15a), (15b), (15c), (15d) are formed at intervals along the circumference on the outer peripheral surface. As shown in FIGS. 4 and 5, two through-holes (16a), (16b) are formed on the portions facing each other near the center in the axial direction of chamber (11). Also, in the portion on chamber (11) corresponding to through-hole (16a), downstream tube (13) is set, and the interior of chamber (11) and flow channel (13a) formed inside downstream tube (13) communicate with each other via through-hole (16a). Also, upstream tube (14) is set on the portion of chamber (11) corresponding to through-hole (16b), and the interior of chamber (11) and flow channel (14a) formed inside upstream tube (14) are connected to each other via through-hole (16b).

The downstream tube (13) is integrated with chamber (11), and it is composed of base end portion (13b) positioned on the side near chamber (11), and male luer portion (13c) positioned toward the end and formed narrower than base end portion (13b). Also, male luer portion (13c) is gradually tapered from the side near base end portion (13b) toward the end. At the boundary between base end portion (13b) and male luer portion (13c) on the outer peripheral surface of downstream tube (13), protrusion (13d) is formed along the circumference. Also, said upstream tube (14) is integrated with chamber (11), and flow channel (14a) within is tapered shape to have a smaller diameter on the side near through-hole (16b) and with the diameter gradually increasing away from through-hole (16b). Also, threaded portion (14b) for connection is formed on the outer periphery of the opening portion of upstream tube (14).

Additionally, engagement recess (11a) for attachment of mixing tube (12) is formed on the inner side of the peripheral edge portion of the upper opening portion of chamber (11), and engaging protrusion (11b) for attachment of cap (27) (explained below) is formed on the outside on the peripheral edge of the upper opening of chamber (11). In said chamber (11), longitudinal wall (17) is set upward from near the center in the front/rear direction (left/right direction in FIGS. 4 and 5) on the inner bottom surface of chamber (11).

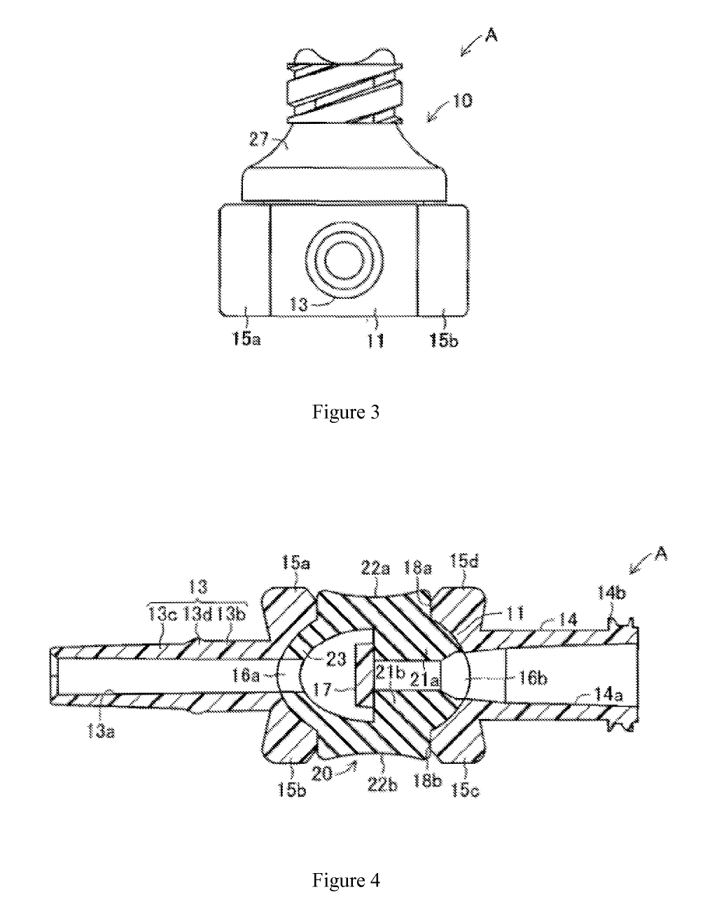

The longitudinal wall (17) arranged so that it covers the central side portion in the width direction (up/down direction in FIG. 4) orthogonal to the direction that connects the portion on the side of flow channel (13a) and the portion on the side of flow channel (14a) inside chamber (11). The upper end extends slightly to the upper side with respect to the upper end opening portion of chamber (11). On the two side portions of chamber (11) (the left/right sides shown in FIG. 3), rectangular hole portions (18a), (18b) are formed opposite each other and that pass through from the interior to the outside of chamber (11), and, through said hole portions (18a), (18b), open/close manipulating part (20) is assembled to go from the interior of chamber (11) to the outside.

The open/close manipulating part (20) is formed as a molding from deformable rubber. It is composed of open/close parts (21a), (21b) as the deformable parts in the present invention set between longitudinal wall (17) and the walls on the side near upstream tube (14) in chamber (11), compressible parts (22a), (22b) connected to the portions corresponding to open/close parts (21a), (21b) and positioned at hole portions (18a), (18b), respectively, and connecting portion (23) that connects the portions on the side of downstream tube (13) between compressible parts (22a), (22b). Here, a prescribed spacing is set between compressible parts (22a), (22b) and the two side portions of longitudinal wall (17) facing them, and said spacing allows deformation of open/close parts (21a), (21b) and compressible parts (22a), (22b) towards the center side in the width direction.

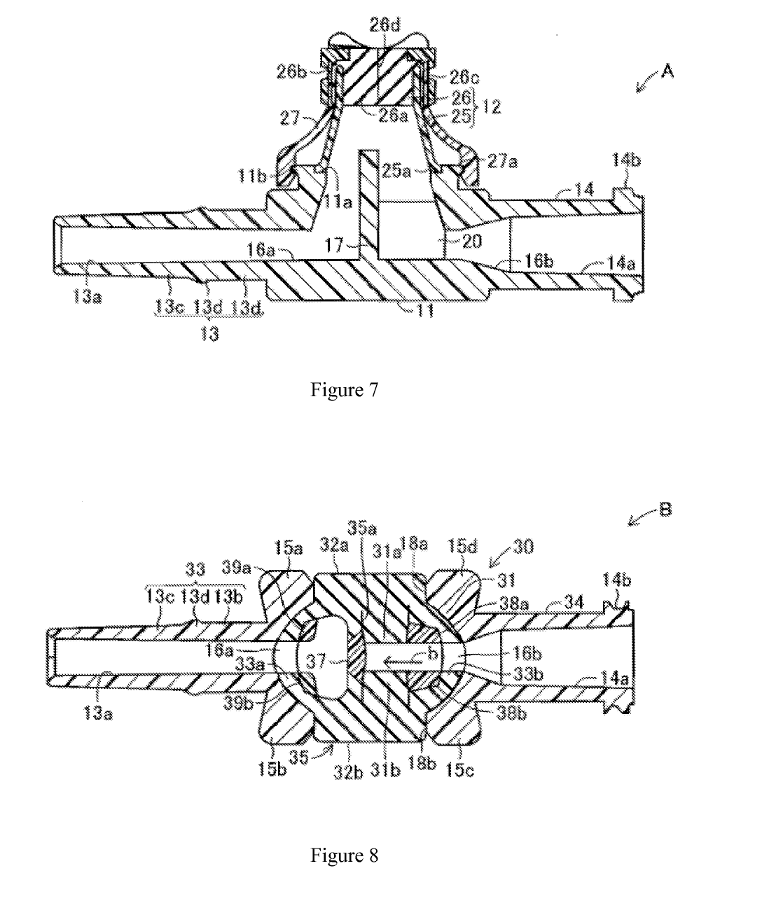

As a result, when compressible parts (22a), (22b) of said open/close manipulating part (20) with said constitution are pressed and deform towards the interior of chamber (11), the opposing surfaces of open/close parts (21a), (21b) come in contact with each other, and as shown in FIGS. 6 and 7, the flow channel between the interior of chamber (11) and flow channel (14a) of upstream tube (14) is blocked. In this case, longitudinal wall (17) guides the movement of open/close parts (21a), (21b), and at the same time defines the movement of compressible parts (22a), (22b), so that deformation of compressible parts (22a), (22b) does not become uncontrolled.

On the other hand, when the force applied to press compressible parts (22a), (22b) towards the interior of chamber (11) is released, due to the restoring force of open/close manipulating part (20), open/close parts (21a), (21b) separate from each other, and as shown in FIGS. 4 and 5, the interior of chamber (11) and flow channel (14a) of upstream tube (14) are connected to each other. In this case, as medicinal liquid or the like is fed from the side of upstream tube (14) to the side of chamber (11), after the medicinal liquid or the like flows from flow channel (14a) into the flow channel formed between open/close parts (21a), (21b) and passes over longitudinal wall (17), it flows from the portion on the side of downstream tube (13) in chamber (11) into flow channel (13a) of downstream tube (13).

In this case, while longitudinal wall (17) prevents the backflow of the medicinal liquid or the like, as the medicinal liquid or the like passes the upper side inside chamber (11), the stagnation of air inside chamber (11) can be prevented. Also, connecting portion (23) is engaged with the inner wall of chamber (11), and open/close manipulating part (20) does not leave the interior of chamber (11) even when open/close manipulating part (20) deforms. Also, the main flow channel of the present invention is formed by flow channel (14a) of upstream tube (14), flow channel (a) that passes from the portion on the side of upstream tube (14) inside chamber (11) over longitudinal wall (17) to the portion on the side of downstream tube (13), and flow channel (13a) of downstream tube (13).

The mixing tube (12) is composed of approximately cylindrically shaped upstream mixing tube (25) attached on the upper end portion of chamber (11) and rubber stopper (26) made of natural or synthetic rubber and attached on the upper end opening portion of upstream mixing tube (25). Said upstream mixing tube (25) is a short cylindrical body that tapers from a large-diameter lower end to a smaller diameter upper end. It is fixed to chamber (11) by engaging lower end peripheral edge portion (25a) to engagement recess (11a) formed on the interior upper end portion of chamber (11).

The rubber stopper (26) is composed of thick disk-shaped stopper main body (26a) and approximately ribbon-shaped fixed pieces (26b), (26c) that extend from the two sides of the upper end of stopper main body (26a). Rubber stopper (26) is fixed in position by pressing stopper main body (26a) from the upper end opening portion of upstream mixing tube (25) into upstream mixing tube (25), setting fixed pieces (26b), (26c) are along the outer peripheral surface of upstream mixing tube (25), and fixing cap piece (27) on the outer side of upstream mixing tube (25). That is, a hole is formed at the center of the top surface of cap piece (27), and cap piece (27) is fixed in position as fixed pieces (26b), (26c) press against the sides of upstream mixing tube (25), while the peripheral edge portion on the upper surface of stopper main body (26a) press against the sides of upstream mixing tube (25) to prevent the stopper from being pulled out.

Additionally, slit (26d) is formed in said rubber stopper (26), so that the inside of upstream mixing tube (25) and the outside of upstream mixing tube (25) are connected to each other to form a secondary flow channel in the present invention. This slit (26d) is closed by the elasticity of rubber stopper (26) when it is not used as the secondary flow channel. On the other hand, when it is used as the secondary flow channel, the secondary flow channel may be formed via a connector or the like by inserting said connector or the like (not shown in the figure). For example, said connector has a male luer portion with an interior flow channel. By inserting the male luer portion into slit (26d) of rubber stopper (26), it is possible to connect the connector and the interior of upstream mixing tube (25) to each other. Also, in this case, the portion between said male luer portion and the peripheral surface of slit (26d) is tightly sealed by the elasticity of rubber stopper (26).

Further, cap piece (27) is attached to the peripheral side of the upper end opening portion of the chamber (11) so that mixing tube (12) is covered, and it is formed as a cylindrical body that tapers from a large diameter on the side of chamber (11) to a gradually smaller diameter at the upper end. Also, said cap piece (27) is formed with an elliptic shape in plan view. Engagement portion (27a) is formed on the lower end of the inner peripheral surface of cap piece (27). This engagement portion (27a) engages with engaging protrusion (11b) formed on the outside of the upper end portion of chamber (11) so that cap piece (27) is fixed on chamber (11).

In this constitution, when a prescribed medicinal liquid is to be fed into the body of a patient (not shown in the figure), the distal end of a transfusion tube (not shown in the figure), the other end of which has a holding needle connected to it that is to be inserted into and fixed on the body of the patient, is connected to downstream tube (13). Also, the male luer portion that is set at the end of the transfusion tube that extends from the container that contains the medicinal liquid to be fed to the patient is connected to upstream tube (14). Then, while the inserted holding needle is fixed to the body of the patient, the medicinal liquid in the container is fed toward and into the body of the patient. When a second medicinal liquid or the like is to be fed to the patient in addition to the medicinal liquid fed from the container or the like, said second medicinal liquid or the like is fed from mixing tube (12) into chamber (11) via the transfusion tube connected to the connector.

That is, as the connector is inserted into slit (26d) of rubber stopper (26) in mixing tube (12), the connector and downstream tube (13) are connected via flow channel (a) inside chamber (11), so that the medicinal liquid or the like is injected from the side of the connector, and the medicinal liquid or the like is fed to the patient. In this case, by pushing compressible parts (22a), (22b) of open/close manipulating part (20) into the interior of chamber (11), as shown in FIGS. 6 and 7, the portion between open/close parts (21a), (21b) is blocked. As a result, the feeding of the medicinal liquid from the container to flow channel (a) is stopped, and at the same time, the backflow of the medicinal liquid or the like that has been injected from mixing tube (12) into chamber (11) to the upstream side of upstream tube (14) can be prevented, so that the medicinal liquid can reliably flow to the downstream side of downstream tube (13).

Also, after the end of injection of the medicinal liquid or the like from the connector side, the pressure on compressible parts (22a), (22b) is released, and the opposing portions of open/close parts (21a), (21b) are opened so that the medicinal liquid can again be fed from the container to the patient. Also, a small quantity of the medicinal liquid is evacuated from the end of the holding needle before the holding needle is applied to penetrate the body of the patient, where it is and held. As a result, it is possible to evacuate the air in the flow channel to the outside together with the medicinal liquid. Also, as the medicinal liquid, which flows from the side of upstream tube (14) through flow channel (a) inside chamber (11) to the side of downstream tube (13), passes through the interior of chamber (11), it passes over longitudinal wall (17) and the upper side of the interior of chamber (11), so that the stagnation of the air inside chamber (11) can be prevented.

Liquid coinfusion unit A in the present embodiment contains open/close manipulating part (20) composed of open/close parts (21a), (21b) that open/close flow channel (a) inside chamber (11) and compressible parts (22a), (22b) for blocking open/close parts (21a), (21b). As a result, by applying pressure to compressible parts (22a), (22b), the flow of the medicinal liquid from upstream tube (14) to chamber (11) can be stopped, and then application of pressure to compressible parts (22a), (22b) can be stopped. Consequently, it is possible to feed the medicinal liquid or the like from upstream tube (14) via flow channel (a) of chamber (11) to downstream tube (13).

Further, mixing tube (12), which can form the secondary flow channel, is set on the upper side of chamber (11). Consequently, since the connector is connected to mixing tube (12) and the portion on the side of the connector and chamber (11) are connected to each other so that the medicinal liquid or the like is fed from the secondary flow channel to the main flow channel inside chamber (11), it is possible to feed another medicinal liquid or the like via the secondary flow channel from chamber (11) to downstream tube (13). As a result, it is possible to feed either one type of medicinal liquid or the like or two types of medicinal liquid or the like to the body of the patient.

Further still, while said compressible parts (22a), (22b) are in the manipulated state, as the medicinal liquid or the like is fed from the side of mixing tube (12), said medicinal liquid or the like flows to downstream tube (13) on the downstream side of the main flow channel without flowing back to upstream tube (14) on the upstream side. As a result, the appropriate quantity of medicinal liquid or the like fed from the side of mixing tube (12) is not diluted by mixing with the medicinal liquid on the upstream side. Instead, it is fed unchanged to the body of the patient suitably and quickly. Also, only when compressible parts (22a), (22b) are manipulated, is the portion between upstream tube (14) and chamber (11) in the main flow channel blocked. As a result, when a small quantity of the medicinal liquid or the like is fed from the side of mixing tube (12) to the main flow channel, the operation can be performed easily, and at the same time, the medicinal liquid or the like can be fed appropriately. Also, when open/close parts (21a), (21b) are driven (deformed) to open/close, longitudinal wall (17) guides said open/close parts (21a), (21b), so that open/close parts (21a), (21b) deform to the appropriate degree to open/close the flow channel.

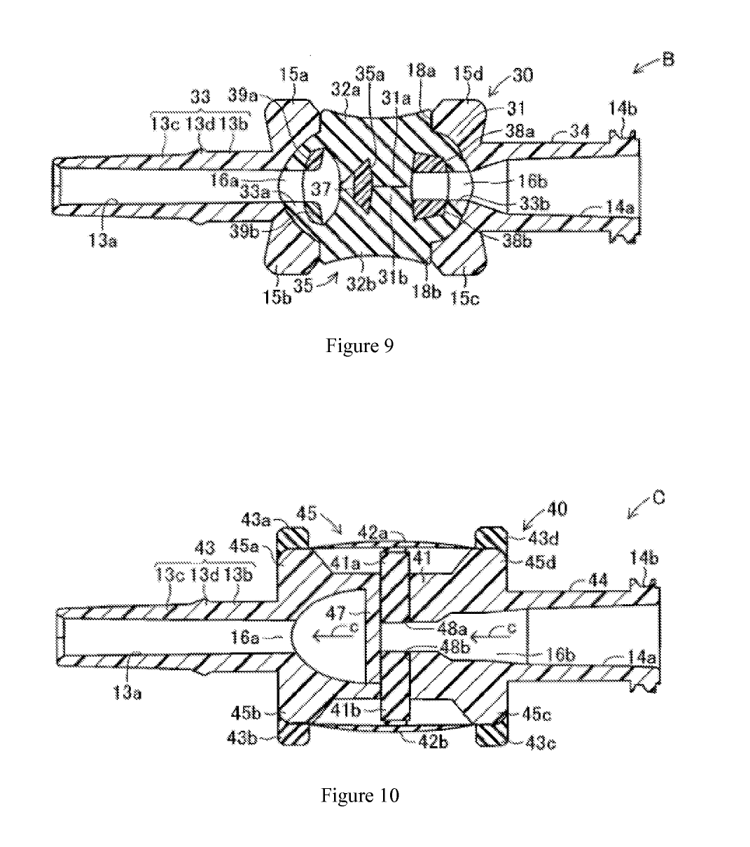

In another embodiment of the present invention, FIGS. 8 and 9 illustrate liquid coinfusion unit B. This liquid coinfusion unit B is composed of liquid coinfusion unit main body (30) and open/close manipulating part (35). Longitudinal wall (37) formed on the bottom surface of chamber (31) contained in liquid coinfusion unit main body (30) has a smaller width than that of longitudinal wall (17) of said liquid coinfusion unit A, and it is formed in an arc-like shape, with the central portion protruding from the two side portions towards the side of upstream tube (34) in a plan view of the surface on the side of longitudinal wall (37) near upstream tube (34).

Further, in the interior portion of chamber (31) on the side of upstream tube (34), a pair of opposing guide pieces (38a), (38b) are formed on either side of flow channel (b), and in the interior portion of chamber (31) on the side of downstream tube (33), a pair of opposing supporting pieces (39a), (39b) are formed on either side of flow channel (b). The shape of the plan view surface of guide pieces (38a), (38b) on the side of downstream tube (33) and the overall shape of the hypothetical extension line (not shown in the figure) connecting them is that of an arc, where the central portion protrudes from the two side portions towards the side of downstream tube (33).

The open/close manipulating part (35) is composed of open/close parts (31a), (31b) with longitudinal wall (37) arranged inside chamber (31) and opposing guide pieces (38a), (38b) on either side of flow channel (b), compressible parts (32a), (32b) respectively connected to the portions corresponding to said open/close parts (31a), (31b), and connecting parts (33a), (33b) that connect the two side portions of said compressible parts (32a), (32b). The prescribed portions on the inner surfaces of said compressible parts (32a), (32b) are in contact with longitudinal wall (37), guide pieces (38a), (38b) and supporting pieces (39a), (39b), and at the boundary portions (central side portions) of the four locations between open/close parts (31a), (31b) and compressible parts (32a), (32b), slits (35a) are formed extending along the width direction, respectively.

As a result, when pressure is applied to compressible parts (32a), (32b), they respectively deform towards the inside of chamber (31), and open/close parts (31a), (31b) now in contact with each other cause the inner surfaces of slits (35a) to press against longitudinal wall (37) and guide pieces (38a), (38b). As shown in FIG. 9, in flow channel (b), the portion between chamber (31) and upstream tube (34) is blocked. In this case, because the surface of longitudinal wall (37) on the side of upstream tube (34) and the surfaces of guide pieces (38a), (38b) on the side of downstream tube (33) are in the form of opposing convex arcs, the facing side portions of open/close parts (31a), (31b) having tapered end portions are in contact with each other. On the other hand, when the force used to push compressible parts (32a), (32b) towards the inside of chamber (31) is released, due to the restoring force of open/close manipulating part (35), open/close parts (31a), (31b) separate, and as shown in FIG. 8, connecting the portion in flow channel (b) between chamber (31) and upstream tube (34).

Additionally, connecting portion (33a) engages with the inner wall of chamber (31) and supporting pieces (39a), (39b), and connecting portion (33b) engages with the inner wall of chamber (31) and guide pieces (38a), (38b). As a result, even when open/close manipulating part (35) is deformed, it cannot escape from the interior of chamber (31). The constitution of the remaining portions of said liquid coinfusion unit B is the same as that of said liquid coinfusion unit A. Thus, the same part numbers are used, and their explanation will not be repeated.

Consequently, since longitudinal wall (37) and guide pieces (38a), (38b) for guiding open/close parts (31a), (31b) are set in chamber (31), open/close parts (31a), (31b) remain in an appropriate state of deformation. Also, since the surface of longitudinal wall (37) on the side of upstream tube (34) and the surfaces of guide pieces (38a), (38b) on the side of downstream tube (33) are in the form of opposing convex arcs, and slits (35a) are formed at the boundary portions between open/close parts (31a), (31b) and compressible parts (32a), (32b), the operation for blocking open/close parts (31a), (31b) can be performed smoothly. The remaining features of the operation and effects of this liquid coinfusion unit B are the same as those of said liquid coinfusion unit A.

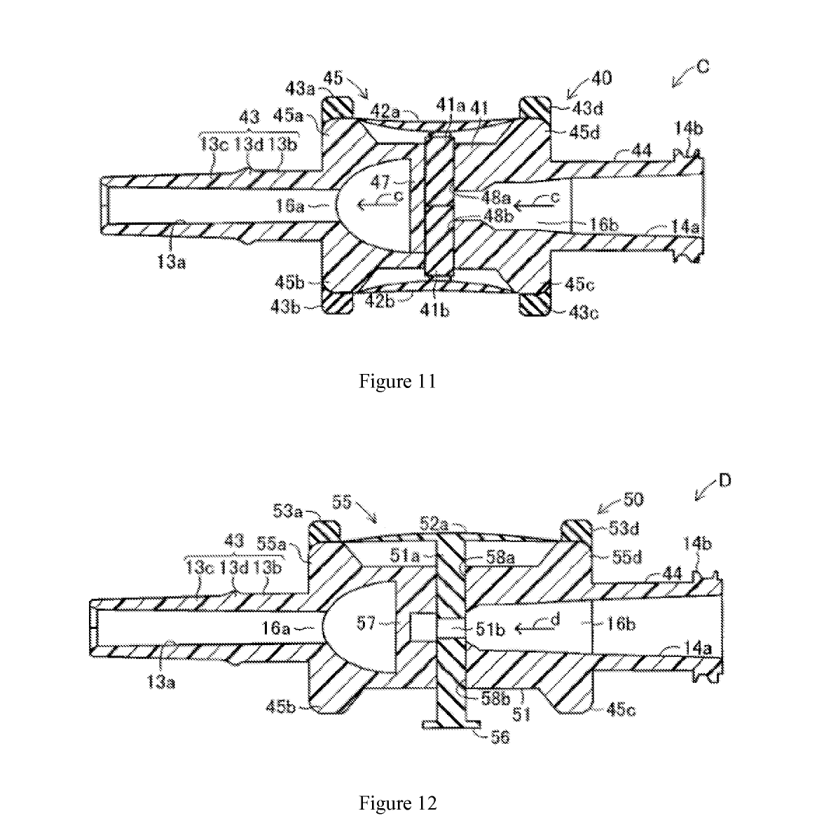

In yet another embodiment of the present invention, FIGS. 10 and 11 illustrate liquid coinfusion unit C. This liquid coinfusion unit C is composed of liquid coinfusion unit main body (40) and open/close manipulating part (45). Longitudinal wall (47) formed on the bottom surface of chamber (41) contained in liquid coinfusion unit main body (40) is integrated with chamber (41) extending to the two inner walls of chamber (41). Consequently, said longitudinal wall (47) is formed so that the entire area between the front side and the rear side inside chamber (41) in the width direction can be blocked. Also, the part of chamber (41) that forms flow channel c from the portion on the side of upstream tube (44) to the side portion of downstream tube (43) via the upper portion of longitudinal wall (47) forms a small portion with a small end that extends straight with the same diameter as that in approximately the central portion of chamber (41) such that the portion on the side upstream tube (44) is continuous from flow channel (14a) of upstream tube (44).

The portion on the side of downstream tube (43) inside said chamber (41) is formed along the outer shape of chamber (41) and forms an approximately semicircular space in plan view. As a result, a step is formed within chamber (41), in the width direction of the boundary portion between the portion on the side of upstream tube (44) and the portion on the side of downstream tube (43). In this step portion (the portion on the side of upstream tube (44) adjacent to longitudinal wall (47)), continuous hole portions (48a), (48b) are formed from the outer surface of chamber (41) to the inner surface. The width of said hole portions (48a), (48b) is made smaller than the width of hole portions (18a), (18b) of said liquid coinfusion unit A.

The open/close manipulating part (45) is composed of open/close pieces (41a), (41b) that are opposing each other and movable through-hole portions (48a), (48b) of chamber (41) with flow channel (c) between them, elastic manipulating pieces (42a), (42b) set connected to the outer side end portions of open/close pieces (41a), (41b), respectively, holding protrusions (45a), (45d) and holding protrusions (45b), (45c) on the two side portions of elastic manipulating pieces (42a), (42b), as well as fixing portions (43a), (43d) and fixing portions (43b), (43c) fixed on said holding protrusions, respectively. Said open/close pieces (41a), (41b) are approximately rod-shaped and can move inside hole portions (48a), (48b) while the surface on the side of longitudinal wall (47) slides on longitudinal wall (47) and is guided by longitudinal wall (47).

Further, said elastic manipulating pieces (42a), (42b) are formed as thin sheets extending in the front/rear direction (left/right direction in FIGS. 10 and 11), with the inner surface on the side of chamber (41) formed as a plane, and with the outer surface formed as a curved surface with the central portion in the front/rear direction protruding to the outer side with respect to the two side portions. Consequently, the central portions of elastic manipulating pieces (42a), (42b) in the front/rear direction are thicker, and the thickness decreases from the central portion to the two sides. Also, elastic manipulating pieces (42a), (42b) energize the corresponding open/close pieces (41a), (41b) toward the outside, and the end portions of open/close pieces (41a), (41b) on the inside of chamber (41) are positioned at the openings of the inner side of hole portions (48a), (48b).

Consequently, when elastic manipulating pieces (42a), (42b) are pressed toward the inside of chamber (41) and bent such that the inner surface of elastic manipulating pieces (42a), (42b) protrude towards the side of chamber (41), open/close pieces (41a), (41b) move towards the inside of chamber (41) along the inner surfaces of hole portions (48a), (48b) and longitudinal wall (47). Since the opposing end portions of open/close pieces (41a), (41b) are in contact with each other, as shown in FIG. 11, flow channel (c) is blocked. On the other hand, when the force pressing elastic manipulating pieces (42a), (42b) towards the interior of chamber (41) is released, due to the restoring force of elastic manipulating pieces (42a), (42b), said open/close pieces (41a), (41b) separate, and as shown in FIG. 10, connect flow channel (c) between chamber (41) and upstream tube (44).

The constitution of the remaining portions of said liquid coinfusion unit C is the same as that of said liquid coinfusion unit A. As a result, the same part numbers as those adopted above are used here and will not be explained again. Thus, because open/close pieces (41a), (41b) are rod-shaped, the displacement path of open/close pieces (41a), (41b) will be correct. Also, because the manipulatable surfaces of elastic manipulating pieces (42a), (42b) are selectively large, operation becomes easier. The remaining features of the operation and effects of this liquid coinfusion unit C are the same as those of said liquid coinfusion unit A.

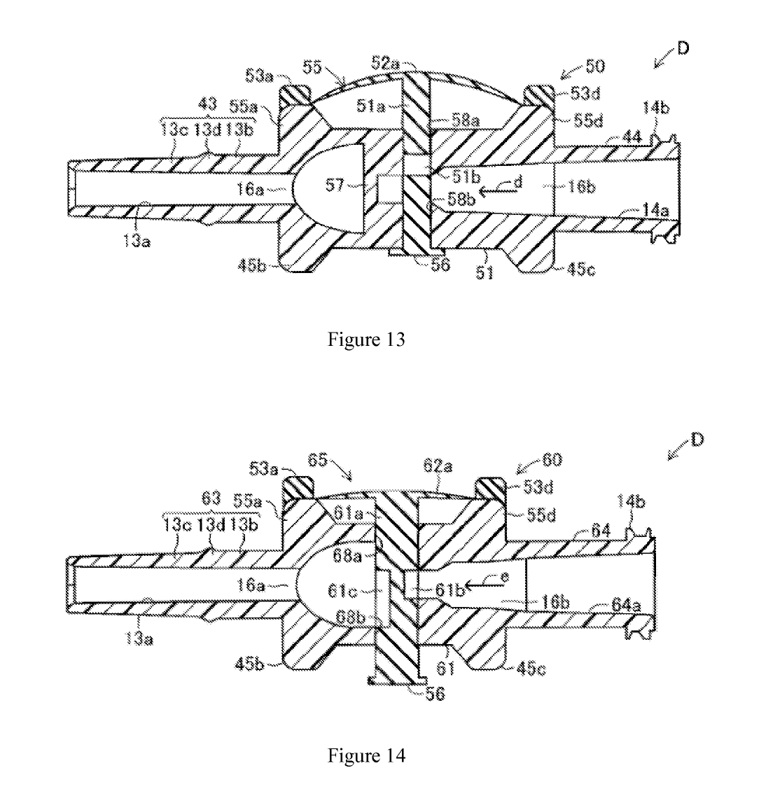

In yet another embodiment of the present invention, FIGS. 12 and 13 illustrate liquid coinfusion unit D. Liquid coinfusion unit D is composed of liquid coinfusion unit main body (50) and open/close manipulating part (55). Longitudinal wall (57) of chamber (51) contained in liquid coinfusion unit main body (50) is set in the front side portion with respect to the central area in the front/rear direction of chamber (51). Said longitudinal wall (57) extends to the two inner walls of chamber (51), and it is integrated with chamber (51). Also, on the portion with a certain spacing from longitudinal wall (57) in the central portion in the front/rear direction of chamber (51), continuous hole portions (58a), (58b) are formed from the inner surface to the outer surface of chamber (51).

The open/close manipulating part (55) is composed of moving piece (51a) movably arranged through hole portions (58a), (58b) of chamber (51), elastic resetting piece (52a) connected to one end of moving piece (51a), fixing portions (53a), (53d) that fix the two side portions of elastic resetting piece (52a) on convex holding parts (55a, (55b), and manipulating piece (56) connecting to and the other end of moving piece (51a). Connecting hole (51b) that forms a portion of flow channel (d) is formed in approximately the central portion of the longitudinal direction (the width direction of chamber (51)) of moving piece (51a). Additionally, said elastic resetting piece (52a) is formed as the same part as said elastic manipulating piece (42a), and moving piece (51a) is supported so that connecting hole (51b) is located inside flow channel (d).

Consequently, as manipulating piece (56) is pushed towards the inside of chamber (51) and moving piece (51a) is driven to move so that it protrudes to the outside of elastic resetting piece (52a), connecting hole (51b) moves inside hole portion (58a), and as shown in FIG. 13, flow channel (d) is blocked by the portion of moving piece (51a) outside of connecting hole (51b). In this case, because elastic resetting piece (52a) is bent towards the outside, if the force for pressing manipulating piece (56) towards the inside of chamber (51) is released, due to the restoring force of elastic resetting piece (52a), moving piece (51a) moves to its original position. As a result, as shown in FIG. 12, connecting hole (51b) is positioned inside flow channel (d), and flow channel (d) in chamber (51) is connected.

Additionally, no fixing portions corresponding to fixing portions (43b), (43c) of liquid coinfusion unit C are set for this liquid coinfusion unit D. The constitution of the remaining portions of liquid coinfusion unit D is the same as that of said liquid coinfusion unit C. As a result, the same part numbers as those adopted above are used, and will not be explained again. As a result, the operation for blocking flow channel (d) becomes simpler since only manipulating piece (56) must be pressed to one side. The remaining features of said liquid coinfusion unit D are the same as those of said liquid coinfusion unit C.

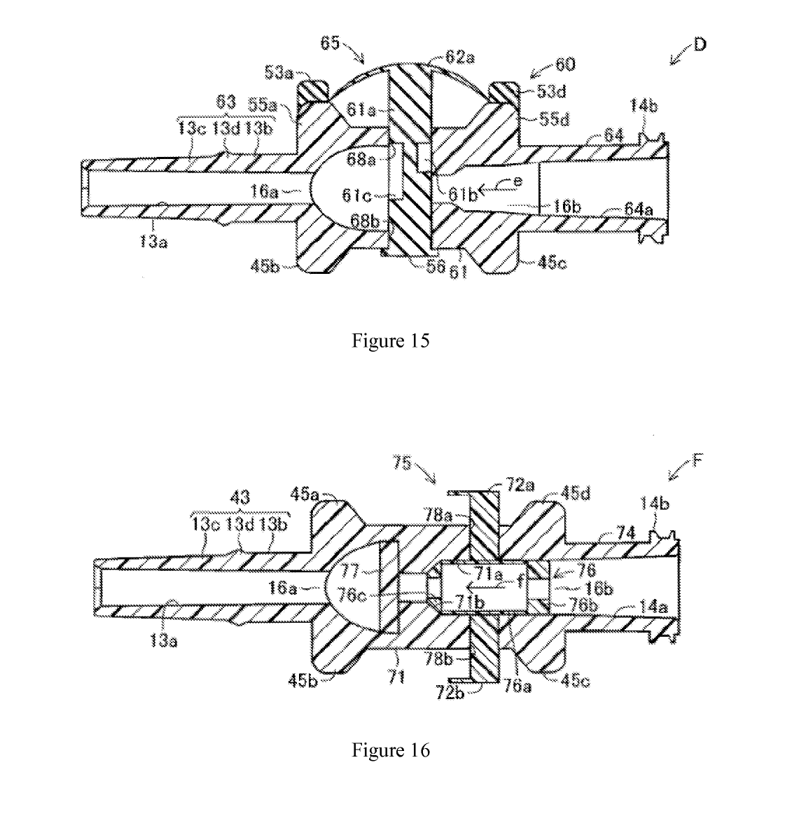

In a further embodiment of the present invention, FIGS. 14 and 15 illustrate liquid coinfusion unit E. For the liquid coinfusion unit E, no longitudinal wall is set on chamber (61) of the liquid coinfusion unit main body (60). Instead, in the central portion in the front/rear direction of chamber (61), hole portions (68a), (68b) are formed with a larger diameter and length than those of hole portions (58a), (58b) of said liquid coinfusion unit D. Also, the width of the portion on the side of downstream tube (63) in the interior of chamber (61) is extended up to the portion where it crosses hole portions (68a), (68b), and the width of the portion on the side of upstream tube (64) in the interior of chamber (61) is reduced up to the portion where it crosses hole portions (68a), (68b).

Further, the width of moving piece (61a) of open/close manipulating part (65) is set such that it fits the width of hole portions (68a), (68b). At approximately the central portion in the longitudinal direction (width direction of chamber (61)) of moving piece (61a), connecting slots (61b), (61c) are formed as a portion of flow channel (e). Said connecting slot (61b) is set at approximately the center in the width direction on the surface on the side of moving piece (61a) near upstream tube (64), and it connects flow channel (64a) of upstream tube (64) and the upper side portion in chamber (61) in flow channel (e).

Additionally, connecting slot (61c) is set approximately at the center in the width direction on the surface of moving piece (61a) on the side of downstream tube (63), and the width of connecting slot (61c) is set to about twice the width of connecting slot (61b). Also, elastic resetting piece (62a) supports moving piece (61a) so that connecting slot (61b) is positioned inside flow channel (e). The features of the constitution of the remaining portions of said liquid coinfusion unit E are the same as those of said liquid coinfusion unit D. As a result, the same part numbers as those adopted above are used here and will not be explained again.

With the aforementioned constitution, when manipulating piece (56) is pressed toward the inside of chamber (61) and moving piece (61a) is driven to move so that it protrudes to the outside of elastic resetting piece (62a), connecting slot (61b) moves inside hole portion (68a), and, as shown in FIG. 15, flow channel (e) is blocked by the portion of moving piece (61a) outside of connecting slot (61b). In this case, since elastic resetting piece (62a) bends towards the outside, if the force applied to press manipulating piece (56) towards the inside of chamber (61) is released, due to the restoring force of elastic resetting piece (62a), moving piece (61a) is driven to move to its original position. As a result, as shown in FIG. 14, connecting slot (61b) becomes positioned inside flow channel (e), and flow channel (e) inside chamber (61) is connected. The features of the remaining operation and effects of this liquid coinfusion unit E are the same as those of said liquid coinfusion unit D.

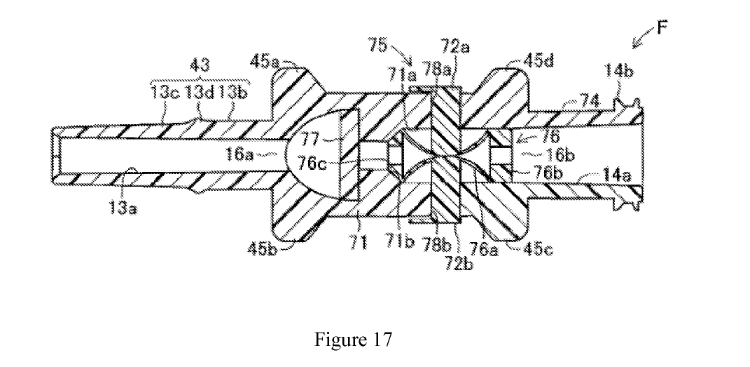

In another embodiment of the present invention, FIGS. 16 and 17 illustrate liquid coinfusion unit F. For this liquid coinfusion unit F, the portion of hole portion (71a) for forming the flow channel (f) inside chamber (71) on the side of upstream tube (74) extends straight with the same diameter, and the portion from approximately the central portion of hole portion (71a) for forming said flow channel to longitudinal wall (77) is formed with a small diameter. At the boundary between the uniform-diameter portion and the smaller-diameter portion in hole portion (71a), tapered portion (71b) with a diameter that is gradually reduced from the uniform-diameter portion to the smaller-diameter portion is formed. Elastic cylindrical body (76) of open/close manipulating part (75) is set from said tapered portion (71b) to approximately the end portion of hole portion (71a) on the side of upstream tube (74).

Said elastic cylindrical body (76) is made of molded rubber and is composed of thin-walled elastic cylindrical portion (76a), thick-walled upstream annular portion (76b) connected to the upstream end of elastic cylindrical portion (76a) and with a hole formed at the center, and thick-wall downstream ring portion (76c) connected to the downstream end of elastic cylindrical portion (76a) and with a hole formed at the center. On the outer peripheral surface of downstream annular portion (76c), a tapered surface is formed along tapered portion (71b) of hole portion (71a) for forming the flow channel. Also, on the portion of chamber (71) corresponding to approximately the central portion in the axial direction of elastic cylindrical body (76) (the portion of chamber (71) on the side of upstream tube (74) with respect to the central portion in the front/rear direction), continuous hole portions (78a), (78b) are formed from the inner surface of chamber (71) to the outer surface. Also, from the two side portions of elastic cylindrical body (76), a pair of compression parts (72a), (72b) pass through-hole portions (78a), (78b) and extend to the outside.

Each of compression parts (72a), (72b) is formed from an approximately L-shaped piece with the end portion on the outside wider so as to facilitate the pressing operation. As a result, when compression parts (72a), (72b) are pressed towards the inside of chamber (71) and the opposing side surfaces of elastic cylindrical body (76) are pressed, as shown in FIG. 17, the central portion of elastic cylindrical portion (76a) deforms that flow channel (f) is blocked. On the other hand, when the force for pushing compression parts (72a), (72b) towards the inner side of chamber (71) is released, due to the restoring force of elastic cylindrical portion (76a), elastic cylindrical body (76) recovers its original shape, and as shown in FIG. 16, flow channel (f) in elastic cylindrical body (76) is connected. The features of the remaining portions of liquid coinfusion unit F are the same as those of said liquid coinfusion unit C. Consequently, the same part numbers as those adopted above are used here and will not be explained again. As a result, the same operation and effects as those of liquid coinfusion units A, B, etc. in said embodiments can be realized.

The liquid coinfusion unit of the present invention is not limited to the embodiments described, and appropriate modifications can be performed. For example, in said embodiments, slit (26d) is formed on rubber stopper (26), and a male luer portion is inserted into slit (26d) to connect the connector to mixing tube (12). However, one a scheme can also be used in which instead of the connector, the male luer portion of cylinder or a needle of syringe is inserted into the rubber stopper. When a syringe needle is inserted, there is no need to set slit (26d) on rubber stopper (26). Also, in said Embodiment 5, for liquid coinfusion unit E, two connecting slots, that is, connecting slots (61b), (61c), are set on moving piece (61a). However, one may also adopt a scheme in which only connecting slot (61b) is formed. In addition, appropriate changes may be adopted for the shape and material of the other portions that form the liquid coinfusion unit.

In order to realize the aforementioned purpose, the present invention provides a liquid coinfusion unit characterized by the fact that it is composed of the following parts: a liquid coinfusion unit main body, which consists of an upstream tube and a downstream tube that extend from the two respective ends of the interior chamber to the outside; and a mixing tube which is formed on the upper side of said chamber and which communicates with a main flow channel that extends from said upstream tube to said downstream tube via said chamber and with a secondary flow channel that can be turned to open/close and that is used to connect said mixing tube and said chamber; an open/close part, which is set in said chamber and can connect/block the portion between said upstream tube and said chamber in said main flow channel by being displaced inside said chamber; and a manipulating part on the outside of said chamber, which is connected to said open/close part and can be manipulated for the displacement of said open/close part.

The liquid coinfusion unit of the present invention with said constitution contains an open/close part, which is set in said chamber and can connect/block the portion between said upstream tube and said chamber in said main channel by being displaced inside said chamber; and a manipulating part outside of said chamber, which is connected to said open/close part and can be manipulated for the displacement of said open/close part. By manipulating the manipulating part from outside of the chamber, it is possible to block or connect the part between the upstream tube and the chamber in the main flow channel. As a result, by manipulating the manipulating part, it is possible to turn on and off the supply of the medicinal liquid or the like from the upstream tube via the chamber to the downstream tube.

Here, “the displacement of the open/close part” means changing the state of the open/close part by, e.g., deformation, movement, etc., so that the main flow channel can be opened/closed. Also, a mixing tube may be arranged on the upstream side of the chamber, and a secondary flow channel that can connect/block the mixing tube and the chamber is formed, so that it is possible to connect or block the flow channel between the mixing tube and the chamber. Consequently, by connecting the mixing tube and the chamber and feeding a second medicinal liquid or the like from the secondary flow channel to the main flow channel in the chamber, it is possible to feed said second medicinal liquid or the like via the secondary flow channel from the chamber to the downstream tube portion in the main flow channel.

Further, the secondary flow channel can be connected or blocked. This may be performed, for example, by attaching a rubber stopper in the branched tube to block the secondary flow channel and piercing the rubber stopper with a cylindrically shaped needle, syringe, etc., to connect the secondary flow channel. That is, with said liquid coinfusion unit, it is possible to connect or block the portion between said upstream tube and said chamber in said main flow channel from the upstream tube via the chamber to the downstream tube, and it is also possible to block or connect the secondary flow channel from the mixing tube to the chamber.

Consequently, it is possible to feed one type of medicinal liquid or the like to the body of the patient, or to feed two types of medicinal liquids or the like into the body of the patient. Also, by feeding medicinal liquid or the like from the secondary flow channel to the downstream side of the main flow channel while manipulating the manipulating part to block the main flow channel, said medicinal liquid does not flow back to the upstream side of the main flow channel but flows to the downstream side of the main flow channel. As a result, with the main flow channel blocked, after the required quantity of the medicinal liquid or the like is fed from the secondary flow channel to the downstream side of the main flow channel, the blocking of the main flow channel can be released, so that the medicinal liquid or the like from the upstream side to the downstream side of the main flow channel can flow together with the medicinal liquid or the like fed from the secondary flow channel into the body of the patient. As a result, the desired quantity of medicinal liquid or the like fed from the secondary flow channel can be supplied appropriately and quickly into the body of the patient.

Additionally, the liquid coinfusion unit of the present invention is characterized by the fact that said open/close part is energized in the direction of connecting said upstream tube and said chamber in said main flow channel, so that the portion between said upstream tube and said chamber in said main flow channel can only be blocked if said manipulating part has been manipulated.

Therefore, for example, when a medicinal liquid or the like is fed from the secondary flow channel to the main flow channel, by manipulating the manipulating part to block the upstream side of the main flow channel, it is possible to prevent the medicinal liquid or the like fed from the secondary flow channel from flowing back to the upstream side of the main flow channel, and then, by leaving the manipulating part in this position, it is possible to flow another medicinal liquid or the like from the upstream side to the downstream side of the main flow channel. As a result, when a small quantity of medicinal liquid or the like is to be fed from the secondary flow channel to the main flow channel, the operation becomes easier, and at the same time, it is possible to feed the medicinal liquid or the like appropriately.

Further, the liquid coinfusion unit of the present invention is characterized by the fact that said open/close part is composed of a deformable part made of a flexible elastic body that contains portions on either side of said main flow channel, wherein said manipulating part is composed of compressible parts made of flexible elastic bodies, which are integrated with said deformable part and which extend from the facing of said deformable part on either side of the main flow channel to said chamber exterior.

As a result, if pressure is applied to deform the compressible parts positioned on the two exterior sides of the chamber so that they enter the chamber, the deformable part also deforms, so that the portions of the deformable part where the main flow channel is held come in contact with each other to block the main flow channel. In this case, since the deformable part and compressible parts are flexible elastic bodies, when the pressure applied to the compressible parts is released, the deformable part and the compressible parts recover their original shape so that the main flow channel becomes connected. Also, in this liquid coinfusion unit, it is preferred that a guide part for guiding the displacement (deformation) of said deformable part be arranged within said chamber. As a result, the deformation of the deformable part can take on the prescribed state.

In addition, the liquid coinfusion unit of the present invention is characterized by the fact that said open/close part is composed of a pair of facing open/close pieces that are arranged on either side of the main flow channel and that at the same time extend through the side walls of said chamber to the outside, and by the fact that said manipulating part is composed of a pair of elastic manipulating pieces that are connected to said pair of open/close pieces while said pair of open/close pieces are energized towards the outside of the chamber.

Consequently, by applying pressure to deform the elastic manipulating pieces positioned on the two sides of the chamber so that they enter the chamber and the pair of open/close pieces are pressed toward the interior of the chamber, it is possible to bring the ends of the open/close pieces on either side of the main flow channel in contact with each other in order to block the main flow channel. In this case, since the constitution is such that the open/close pieces of said pair of elastic manipulating pieces are energized towards the outside of the chamber, as the pressure applied to the elastic manipulating pieces is released, the open/close pieces and the elastic manipulating pieces recover their original shape, so that the main flow channel is connected.

Also, the liquid coinfusion unit of the present invention is characterized by the fact that said open/close piece is composed of a moving piece, which passes through the side walls of said chamber and extends to its two exterior sides while said main flow channel is blocked, and which contains a connecting hole formed at a prescribed location to connect said main flow channel, and by the fact that said manipulating part is composed of an elastic resetting piece that energizes one end of said moving piece so that said connecting hole is positioned in said main flow channel, and a manipulating piece that is set on the other end of said moving piece and moves said moving piece against the elastic force of said elastic resetting piece.

As a result, by manipulating the manipulating piece positioned outside of the chamber to deform the elastic resetting piece, it is possible to move the moving piece so that the connecting hole leaves the position of the main flow channel to block the main flow channel. In this case, since the elastic resetting piece energizes the moving piece such that the connecting hole is positioned in the main flow channel, when the manipulating piece is released, the elastic resetting piece and the moving piece recover their original shape to connect the main flow channel.

Further, the liquid coinfusion unit of the present invention is characterized by the fact that said open/close piece is composed of a moving piece, which passes through the side walls of said chamber and extends to its two exterior sides while said main flow channel is blocked, and which contains a connecting slot formed in the upper side at a prescribed location on the surface of its upstream tube side for connecting said main flow channel via the portion of said mixing tube side in said main flow channel, and by the fact that said manipulating part is composed of an elastic resetting piece that energizes one end of said moving piece so that said connecting slot is connected to said main flow channel, and a manipulating piece that is set on the other end of said moving piece and moves said moving piece against the elastic force of said elastic resetting piece.

Consequently, by manipulating the manipulating piece located outside of the chamber to deform the elastic resetting piece, it is possible to move the moving piece so that the connecting slot leaves the position of the main flow channel so that the main flow channel is blocked. In this case, because the elastic resetting piece energizes the moving piece so that the connecting slot is positioned in the main flow channel, when the manipulating piece is released, the elastic resetting piece and the moving piece recover the original shape, the main flow channel is connected.

Additionally, the liquid coinfusion unit of the present invention is characterized by the fact that said open/close piece is composed of an elastic cylindrical body, interior of which forms a part of said main flow channel, and by the fact that said manipulating part is composed of a pair of compressible parts that pass through the side walls of said chamber from the two side portions of said elastic cylindrical body to the outside, wherein, as said pair of compressible parts are driven towards/away from each other, said elastic cylindrical body can be opened/closed.

As a result, by pressing the pair of compressible parts located on the outside of the chamber on either side, so that they enter the interior of the chamber, it is possible to deform the elastic cylindrical body so that the portions of the two side portions of the elastic cylindrical body are in contact with each other to block the main flow channel. Thus, when the elastic cylindrical body recovers its original shape, the main flow channel is connected.

What is claimed is:

1. A liquid coinfusion unit comprising:
a liquid coinfusion unit main body, having an upstream tube and a downstream tube extending outwardly from two respective sides of an interior chamber, and a mixing tube which is formed on an upper part of said chamber and which communicates with a first flow channel that extends from said upstream tube to said downstream tube via said chamber such that a second flow channel extends from said mixing tube to said downstream tube;
a closure mechanism arranged to be able to releasably block said first flow channel; and
a manipulating element outside of said chamber which is connected to said closure mechanism which can be manipulated to displace said closure mechanism.

2. The liquid coinfusion unit according to claim 1 wherein said closure mechanism is biased towards a state in which said first flow channel is open.

3. The liquid coinfusion unit according to claim 1 wherein said closure mechanism comprises a deformable part made of a flexible elastic body having portions on either side of said first flow channel and wherein said manipulating element is composed of flexible elastic compressible parts integrated with said deformable part.

4. The liquid coinfusion unit according to claim 3 wherein said liquid coinfusion unit further comprises a guide part for guiding said deformable part inside said chamber.

5. The liquid coinfusion unit according to claim 1 wherein said closure mechanism comprises a pair of facing pieces arranged on either side of the first flow channel and which extend through side walls of said chamber to the outside, wherein said manipulating part comprises a pair of elastic manipulating pieces that are connected to said pair of facing pieces and wherein said pair of facing pieces are biased towards a state in which said first flow channel is open.

6. The liquid coinfusion unit according to claim 1 wherein said closure mechanism comprises a moving piece, which passes through side walls of said chamber to the exterior and which defines a connecting hole therethrough formed at a prescribed location, said connecting hole being movable from a position in which said connecting hole is aligned with said first flow channel such that said first flow channel is open and a position in which said connecting hole is displaced from said first flow channel such that said first flow channel is closed and wherein an elastic biasing element is provided which biases said moving piece such that said first flow channel is open, and said manipulating element is arranged on an opposite side of said chamber to said biasing element and is arranged to exert a force on said moving piece against the biasing of the elastic biasing element.

7. The liquid coinfusion unit according to claim 1 wherein said closure mechanism comprises a moving piece, which passes through side walls of said chamber to the exterior and which defines a connecting slot formed in an upper half thereof at a prescribed location at a side facing toward said upstream tube for connecting said first flow channel via the mixing tube with the downstream tube, and wherein said manipulating element comprises an elastic biasing piece that biases one end of said moving piece so that said connecting slot is aligned with said first flow channel, and a manipulating piece on a second end of said moving piece for moving piece against the biasing of said elastic biasing piece.

8. The liquid coinfusion unit according to claim 1 wherein said closure mechanism comprises an elastic cylindrical body an interior of which forming a part of said first flow channel, and wherein said manipulating element comprises a pair of compression members that pass through side walls of said chamber from two side portions of said elastic cylindrical body to the outside, wherein, said pair of compression members are movable towards each other so as to close said elastic cylindrical body to fluid flow therethrough.
